(19) United States
(12) Patent Application Publication
(10) Pub. No.: US 2003/0094323 A1
(43) Pub. Date: May 22, 2003

(54) Foot-operated actuator for an electric wheelchair

(75) Inventor: Aron Martin, Neodesha, KS (US)

Correspondence Address: THOMAS B. LUEBBERING, HOVEY, WILLIAMS, TIMMONS & COLLINS, Suite 400, 2405 Grand, Kansas City, MO, 64108, US

(73) Assignee: PILLAR TECHNOLOGY, INC.

(21) Appl. No.: 09/991,413

(22) Filed: Nov. 16, 2001

(51) Int. Cl. B62K 11/00

(52) U.S. Cl. 180/205

(57) ABSTRACT

A power wheelchair is shifted between a powered mode and a freewheel mode by shifting a foot-operated actuator coupled to the rear portion of the wheelchair.

### BACKGROUND OF THE INVENTION

1. Field of the Invention

The present invention relates generally to power wheelchairs. The invention further concerns a foot-operated actuator for shifting a power wheelchair between a powered mode and a freewheel mode.

2. Discussion of Prior Art

Power wheelchairs are known and have been the subject of increasing development efforts to provide handicapped and disabled persons with independent mobility to assist such persons in leading more normal lives. Power wheelchairs typically include at least one electric motor which provides power to the drive wheels of the chair via a drive train. Many conventional power wheelchairs are difficult to move by means other than the motor because the coupling of the motor to the drive wheels provides resistance to rotation of the drive wheels. This characteristic of conventional power wheelchairs is particularly disadvantageous in situations where the battery of the wheelchair is not charged and the wheelchair needs to be moved. It is also disadvantageous when the wheelchair requires manual guidance to maneuver through tight areas or when the wheelchair is unoccupied and needs to be moved.

Some conventional power wheelchairs include freewheel switches for shifting the drive train between a powered mode, in which the motor is operably coupled to the drive wheels, and a freewheel mode, in which the motor is decoupled from the drive wheels. However, conventional freewheel switches are typically positioned in locations on the wheelchair which are difficult to access. Further, conventional power wheelchairs employing dual independent drive systems have two separate freewheel switches which must be independently actuated in order to achieve freewheel mode. Thus, shifting a conventional power wheelchair between freewheel mode and power mode can be very inconvenient.

### SUMMARY OF THE INVENTION

In accordance with one embodiment of the present invention, a foot-operated actuator for shifting a power wheelchair between a powered mode and a freewheel mode is provided. The wheelchair includes, among other components, a frame, a motor, a drive train, and a powered wheel. The frame presents front, rear, upper, and lower portions. The drive train includes a freewheel switch for selectively coupling and decoupling the motor and the powered wheel. The foot-operated actuator comprises a foot-actuated member and a shifting member. The foot-actuated member is pivotally coupled to the frame and extends from the rear portion of the frame in a direction generally away from the front portion of the frame. The shifting member is coupled between the foot-actuated member and the freewheel switch so that shifting of the foot-actuated member causes shifting of the freewheel switch.

In a further embodiment of the present invention, a method of selectively shifting a power wheelchair between a powered mode and a freewheel mode is provided. The method comprises the steps of: (a) contacting a human foot with a foot-actuated member extending from the rear portion of the power wheelchair; and (b) exerting a force on the foot-actuated member to thereby decouple a powered wheel from a driving relationship with a motor.

The present invention provides a simple system for conveniently shifting a power wheelchair between freewheel and powered modes. The present invention is especially advantageous for powered wheelchairs employing dual independent drive systems. To shift the wheelchair into freewheel mode, a person positioned behind the wheelchair can simply step on the foot-actuated member to thereby cause the foot-actuated member to pivot downward. This downward pivotal movement of the foot-actuated member causes a corresponding pivotal movement of the shifting members. Since each shifting member is coupled to a respective freewheel switch, the pivotal movement of the shifting members causes simultaneous shifting of the freewheel switches into freewheel mode. To shift the wheelchair from freewheel mode to powered mode, a person positioned behind the chair can simply place a foot under the foot-actuated member and cause the foot-actuated member to pivot upward. This upward pivotal movement of the foot-actuated member simultaneously causes the freewheel switches to shift into powered mode. Further advantages of the present invention will become apparent from the detailed description, drawing figures, and claims.

### BRIEF DESCRIPTION OF THE DRAWING FIGURES

Preferred embodiments of the invention are described in detail below with reference to the attached drawing figures, wherein:

FIG. 1 is an isometric view showing the rear and side of a power wheelchair which includes a foot-operated actuator constructed in accordance with a preferred embodiment of the present invention;

FIG. 2 is an isometric view of the bottom rear portion of a powered wheelchair in powered mode with certain components being cut away to more clearly illustrate the foot-operated actuator;

FIG. 3 is an isometric view of the bottom rear portion of a power wheelchair in freewheel mode with certain components being cut away to more clearly illustrate the foot-operated actuator;

FIG. 4 is a top view of the bottom rear portion of a powered wheelchair in powered mode with certain components being cut away to more clearly illustrate the foot-operated actuator; and

FIG. 5 is a top view of the bottom rear portion of a power wheelchair in freewheel mode with certain components being cut away to more clearly illustrate the foot-operated actuator.

### DETAILED DESCRIPTION OF THE PREFERRED EMBODIMENTS

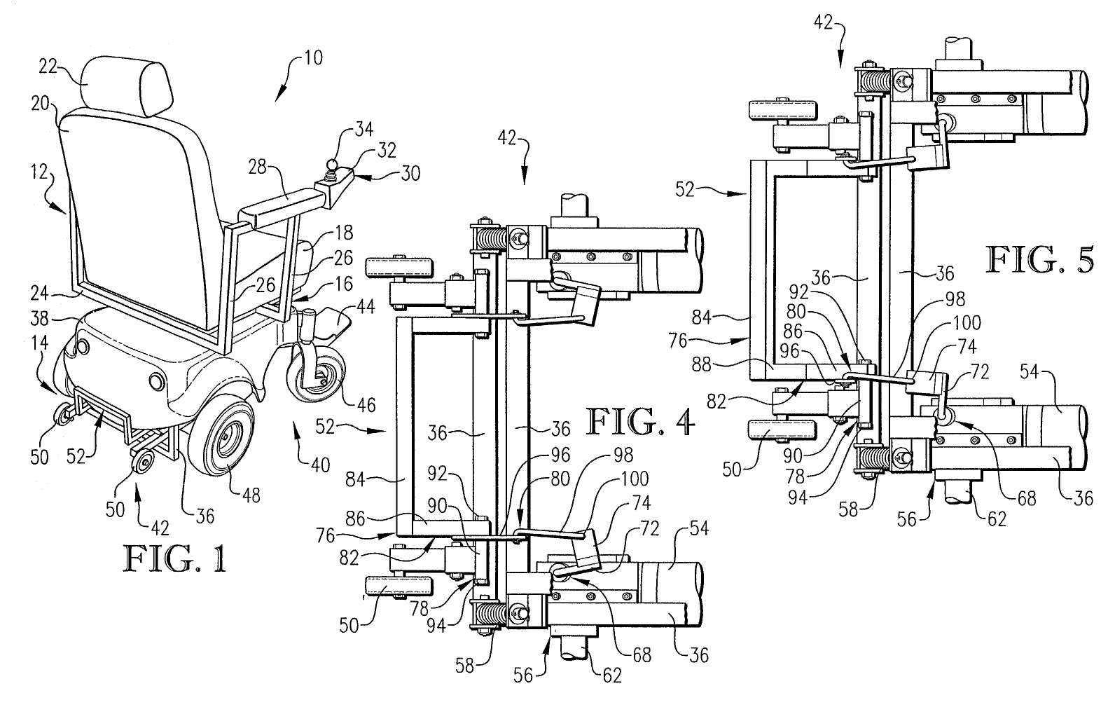

Referring initially to FIG. 1, the power wheelchair 10 selected for illustration generally includes an upper seat portion 12, a lower cart portion 14, and a seat frame 16. Upper seat portion 12 includes a cushion 18, a back rest 20, and a head rest 22. Seat portion 12 is coupled to cart portion 14 via seat frame 16. Seat frame 16 includes lower members 24 which are coupled to the bottom of seat portion 12 and the top of cart portion 14 by any means known in the art. Seat frame 16 further includes upright members 26 which are coupled to and extend generally upwardly from lower members 24. An arm rest 28 is preferably coupled to the top of upright members 26 on each side of seat portion 12. A controller 30 is preferably coupled to the front of arm rest 28. Controller 30 includes a base 32 and a joy stick 34. Joy stick 34 can be easily grasped and manipulated by a user seated in seat portion 12. Controller 30 is operably coupled to a drive means located in cart portion 14, further described below.

Cart portion 14 includes a cart frame 36 and a cover 38. Cart frame 36 presents a front portion 40 and a rear portion 42. A foot plate 44 is preferably coupled to front portion 40 of cart frame 36 to provide a foot rest for a user seated in seat portion 12. A caster wheel 46 is rotatably coupled to front portion 40 of cart frame 36. Drive wheels 48 are rotatably coupled to rear portion 42 of cart frame 36. Rear portion 42 further includes a pair of anti-tip wheels 50 rotatably coupled to rear portion 42 of cart frame 36. Anti-tip wheels 50 are operable to prevent rearward tipping of power wheelchair 10. A foot-operated actuator 52 is pivotally coupled to rear portion 42 of cart frame 36 and extends from a lower part of rear portion 42 in a direction generally away from front portion 40. Foot-operated actuator 52 is shiftable between an up position, wherein power wheelchair 10 is in a powered mode, and a down position, wherein power wheelchair 10 is in a freewheel mode.

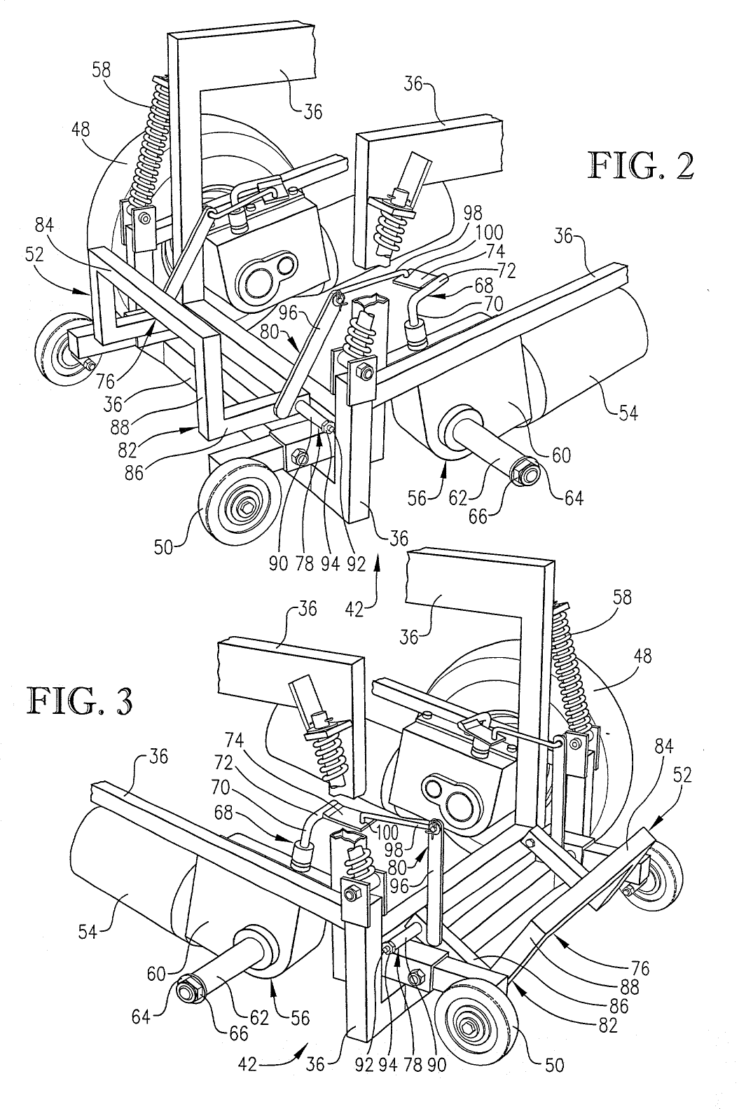

Referring now to FIG. 2, rear portion 42 of cart frame 36 generally supports a motor 54, a drive train 56, and foot-operated actuator 52. Cart frame 36 can include one or more shock absorbers 58 to ensure comfort of the user. The system of the present invention is particularly advantageous for powered wheelchairs which employ independent dual drive systems having two independent motors 54 and drive trains 56. Thus, although the invention is narratively described herein primarily with reference to a single motor 54 and drive train 56, it should be understood, as illustrated in the drawing figures, that the present invention is particularly useful for dual drive systems having a pair of motors 54 and drive trains 56 which are essentially mirror images of one another.

Motor 54 is preferably a conventional electric motor powered by batteries (not shown) and controlled by controller 30 (shown in FIG. 1). Motor 54 is preferably fixedly coupled to frame 36 and is also coupled to a transmission housing 60 of drive train 56. Transmission housing 60 receives a rotating drive shaft of motor 54 and converts that rotational motion into rotation of a drive shaft 62. Drive wheel 48 is preferably coupled for rotation with drive shaft 62 via a washer 64 and a threaded nut 66. Suitable motors and transmissions are available from Rockwell Automation in Eden Prairie, Minn.

A freewheel switch 68 is rotatably coupled to transmission housing 60 and is operably coupled to the internal components of transmission housing 60 so that rotation of freewheel switch 68 causes drive wheel 48 to be coupled and decoupled from motor 54. Freewheel switch 68 includes an L-shaped arm having a first element 70 rotatably coupled to transmission housing 60 and a second element 72 coupled to a shift plate 74 through which a torsional force can be applied to thereby couple and decouple drive wheel 48 and motor 54.

Foot-operated actuator 52 generally includes a foot-actuated member 76, a pivot joint 78, and a shifting member 80. Foot-actuated member 76 is pivotally coupled to the lower rear portion of cart farne 36 so that it is easily actuatable by the foot of a human positioned behind the wheelchair 10. Foot-actuated member 76 extends from cart frame 36 in a direction generally away from front portion 40 of cart frame 36. Foot-actuated member 76 generally includes a pair of spaced apart extension members 82 and a cross-bar 84 fixedly coupled to and extending between extension members 82. Extension member 82 is preferably L-shaped, having an outwardly extending element 86 and an upwardly extending element 88. Outwardly extending element 86 of foot-actuated member 76 is pivotally coupled to cart frame 36 via pivot joint 78. Pivot joint 78 includes a sleeve 90 which is fixedly coupled to frame 36. A bolt 92 can be extended through sleeve 90 and outwardly extending element 86, thereby pivotally coupling foot-actuated member 76 to cart frame 36 when a nut 94 is threaded onto bolt 92.

Shifting member 80 generally includes a base element 96 and a linkage rod 98. Base element 96 preferably has a first end which is fixedly coupled to outwardly extending element 86 of foot-actuated member 76. Base element 80 preferably has a second end which is pivotally coupled to linkage rod 98 by any means known in the art, such as for example, a cotter pin arrangement. Linkage rod 98 preferably has a first end which is pivotally coupled to the second end of base element 80 and a second end which is pivotally received in an opening 100 in shift plate 74 of freewheel switch 68.

FIGS. 2 and 4 show power wheelchair 10 in powered mode with foot-operated actuator being shifted into the up position. In powered mode, motor 54 is operably coupled to drive wheel 48 by drive train 56.

FIGS. 3 and 5 show power wheelchair 10 in freewheel mode with foot-operated actuator 52 being shifted into the down position. In freewheel mode, motor 54 is decoupled from drive wheel 48, thereby allowing drive wheel 48 to turn without resistance from motor 54.

To shift into freewheel mode, a person positioned behind power wheelchair 10 can place a foot on cross-bar 84 and exert a generally downward force on cross-bar 84. The downward force on cross-bar 84 causes extension member 82 to pivot relative to frame 36 at pivot joint 78. The pivoting of extension member 82 causes base element 96 of shifting member 80 to rotate about pivot joint 78. The pivotal movement of base element 96 causes linkage rod 98 to pull freewheel switch 68 into the disengaged position corresponding to freewheel mode of power wheelchair 10. Once in freewheel mode, power wheelchair 10 can be pushed by a human without motor 54 resisting rotation of drive wheel 48.

To shift from freewheel mode into powered mode, a person positioned behind power wheelchair 10 can place a foot under cross-bar 84 and exert a generally upward force on cross-bar 84. The upward force on cross-bar 84 causes extension member 82 to pivot relative to cart frame 36 at pivot joint 78. The pivoting of extension member 82 causes base element 96 of shifting member 80 to rotate about pivot joint 78. The pivotal movement of base element 96 causes linkage rod 98 to push freewheel switch into the engaged position corresponding to the powered mode of power wheelchair 10. Once in powered mode, power wheelchair 10 can be driven and controlled by controlling the rotation of motor 54. In powered mode, drive wheels 48 resist rotation, other than that provided by motor 54.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A foot-operated actuator for shifting a power wheelchair between a powered mode and a freewheel mode, said wheelchair including a frame, a motor, a drive train, and a powered wheel, said frame presenting front, rear, upper, and lower portions, said drive train including a freewheel switch for selectively coupling and decoupling the motor and the powered wheel, said actuator comprising:
a foot-actuated member pivotally coupled to the frame and extending from the rear portion in a direction generally away from the front portion; and
a shifting member coupled between the foot-actuated member and the freewheel switch so that shifting of the foot-actuated member causes shifting of the freewheel switch.

2. The foot-operated actuator as claimed in claim 1,
said foot-actuated member extending from the lower portion of the frame so as to be readily actuatable by a foot.

3. The foot-operated actuator as claimed in claim 2,
said foot-actuated member including an extension member extending generally away from the frame and a cross-bar extending substantially perpendicular to the extension member.

4. The foot-operated actuator as claimed in claim 3,
said extension member having a first end pivotally coupled to the frame and a second end coupled to the cross-bar.

5. The foot-operated actuator as claimed in claim 4,
said shifting member including a base element coupled to the extension member for pivotal movement therewith and a linkage rod pivotally coupled to the freewheel switch.

6. The foot-operated actuator as claimed in claim 5,
said base element having a first end fixedly coupled to the extension member and a second end pivotally coupled to the linkage rod.

7. The foot-operated actuator as claimed in claim 6,
said extension member being generally L-shaped.

8. A foot-operator actuator for shifting a power wheelchair between a powered mode and a freewheel mode, said wheelchair including a frame, a pair of motors, a pair of drive trains, and a pair of powered wheels, said frame presenting front, rear, upper, and lower portions, each of said drive trains including a freewheel switch for selectively coupling and decoupling a respective motor and powered wheel, said actuator comprising:
a foot-actuated member pivotally coupled to the frame and extending from the rear portion in a direction generally away from the front portion,
said foot-actuated member including a pair of spaced apart extension members extending from the frame and a cross-bar coupled to and extending between the extension members; and
a pair of shifting members, each shifting member coupled to a respective extension member and a respective freewheel switch so that shifting of the cross-bar causes simultaneous shifting of the freewheel switches.

9. The foot-operated actuator as claimed in claim 8,
each of said extension members having a first end pivotally coupled to the frame and a second end coupled to the cross-bar.

10. The foot-operated actuator as claimed in claim 9,
each of said shifting members including a base element coupled to a respective extension member for pivotal movement therewith and a linkage rod pivotally coupled to a respective freewheel switch.

11. The foot-operated actuator as claimed in claim 10,
each of said base elements having a first end fixedly coupled to a respective extension member and a second end pivotally coupled to a respective linkage rod.

12. The foot-operated actuator as claimed in claim 11,
said foot-actuated member extending from the lower portion of the frame so as to be readily actuatable by a foot.

13. The foot-operated actuator as claimed in claim 12,
each of said extension members being generally L-shaped.

14. A power wheelchair comprising:
a frame presenting front, rear, upper, and lower portions;
a motor coupled to the frame;
a powered wheel for moving the wheelchair along a supporting surface;
a drive train for operatively coupling the motor and the powered wheel, said drive train including a freewheel switch for selectively coupling and decoupling the drive train and the powered wheel;
a foot-actuated member pivotally coupled to the frame and extending from the rear portion in a direction generally away from the front portion; and
a shifting member coupled to the foot-actuated member and the freewheel switch so that shifting of the foot-actuated member causes shifting of the freewheel switch.

15. The power wheelchair as claimed in claim 14,
said foot-actuated member extending from the lower portion of the frame so as to be readily actuatable by a foot.

16. The power wheelchair as claimed in claim 15,
said foot-actuated member including an extension member extending generally away from the frame and a cross-bar extending substantially perpendicular to the extension member.

17. The power wheelchair as claimed in claim 16,
said extension member having a first end pivotally coupled to the frame and a second end coupled to the cross-bar.

18. The power wheelchair as claimed in claim 17,
said shifting member including a base element coupled to the extension member for pivotal movement therewith and a linkage rod pivotally coupled to the freewheel switch.

19. The power wheelchair as claimed in claim 18,
said base element having a first end fixedly coupled to the extension member and a second end pivotally coupled to the linkage rod.

20. The power wheelchair as claimed in claim 19,
said freewheel switch including a shift plate having an aperture therein for pivotally receiving the linkage rod.

21. The power wheelchair as claimed in claim 20,
said extension member being generally L-shaped.

22. The power wheelchair as claimed in claim 14,
said wheelchair having two of said motors each independently and operatively coupled to a respective drive wheel by a respective drive train,
said foot-actuated member including two of said extension members and a cross-bar coupled to and extending between the extension members,
said wheelchair including two of said shifting members, each coupled to a respective foot-actuated member and a respective freewheel switch,
said freewheel switches simultaneously actuatable by shifting the cross-bar.

23. A method of selectively shifting a power wheelchair between a powered mode and a freewheel mode, said method comprising the steps of:
(a) contacting a human foot with a foot-actuated member extending from a rear portion of the powered wheeled chair; and
(b) exerting a first force on the foot-actuated member to thereby decouple a powered wheel from a driving relationship with a motor.

24. A method as claimed in claim 23; and
(c) exerting a second force on the foot-actuated member to thereby operably couple the powered wheel with the motor, the relative directions of the first and second forces being generally opposite one another.

25. A method as claimed in claim 24,
said powered wheelchair including two independently driven powered wheels which are simultaneously shiftable between powered and freewheel modes by exerting generally downward and upward forces on the foot-actuated member.
